(19) United States
(12) Patent Application Publication
(10) Pub. No.: US 2016/0337993 A1
(43) Pub. Date: Nov. 17, 2016

(54) USER TERMINAL, RADIO BASE STATION AND RADIO COMMUNICATION METHOD

(71) Applicant: NTT DOCOMO, INC., Tokyo (JP)

(72) Inventors: Kazuaki Takeda, Tokyo (JP); Satoshi Nagata, Tokyo (JP)

(73) Assignee: NTT DOCOMO, INC., Tokyo (JP)

(21) Appl. No.: 15/107,470

(22) PCT Filed: Dec. 4, 2014
(86) PCT No.: PCT/JP2014/082138

§ 371 Date: Jun. 23, 2016

(30) Foreign Application Priority Data
Dec. 26, 2013 (JP) 2013-270088

(51) Int. Cl. H04W 56/00; H04J 11/00; H04B 7/02; H04W 16/32; H04L 5/00; H04W 72/04

(52) U.S. Cl. CPC H04W 56/001; H04L 5/0048; H04W 72/042; H04B 7/024; H04W 16/32; H04L 5/0007; H04J 11/005; H04W 88/02

(57) ABSTRACT

A user terminal receives configuration information of each small cell's discovery signal, establishes synchronization in at least one of time and frequency (sync #A) based on the discovery signal configuration information, and acquires first gap information, which represents gap in at least one of time and frequency. Also, the user terminal receives an association indicator, which represents configuration information of a measurement reference signal (CSI-RS) that is associated with a demodulation reference signal (DM-RS) for a downlink shared channel, establishes synchronization (sync #B) based on the configuration information of the measurement reference signal represented by the association indicator, and acquires second gap information, which represents gap in at least one of time and frequency. Thus, when CoMP transmission is executed in a plurality of small cells that use an incompatible carrier, the time/frequency gap in each small cell is corrected.

### TECHNICAL FIELD

The present invention relates to a user terminal, a radio base station and a radio communication method in a next-generation mobile communication system in which small cells are placed within a macro cell.

### BACKGROUND ART

In LTE (Long Term Evolution) and successor systems of LTE (referred to as, for example, “LTE-advanced,” “FRA (Future Radio Access),” “4G,” etc.), a radio communication system (referred to as, for example, a HetNet (Heterogeneous Network), in which cells having a relatively small coverage of a radius of approximately several meters to several tens of meters (hereinafter referred to as “small cells,” and also referred to as “pico cells,” “femto cells” and so on) are placed to overlap a cell having a relatively large coverage of a radius of approximately several hundred meters to several kilometers, is under study (see, for example, non-patent literature 1).

In this radio communication system, carrier aggregation (referred to as “CA”), whereby a plurality of component carriers (referred to as “CCs,” and also referred to as “cells” or simply “carriers”) are bundled into a wide band, is executed. To be more specific, a study is in progress to bundle CCs of a macro cell (referred to as “PCell”) and CCs of at least one small cell (referred to as “SCell”). For example, one CC is formed with a frequency band of approximately 20 MHz, and maximum five CCs are bundled to provide a system bandwidth of maximum 100 MHz.

Also, in the above-described radio communication system, coordinated multi-point (referred to as “CoMP”) transmission is executed. In CoMP, a plurality of transmitting points (referred to as “TPs,” and also referred to as “transmission points,” “transmitting/receiving points,” “cells” and no on) coordinate and transmit user terminals. Note that each transmitting point may be a radio base station to form a macro cell (hereinafter referred to as a “macro base station”), or may be a radio base station to form a small cell (hereinafter referred to as a “small base station”).

### CITATION LIST

### Non-Patent Literature

Non-Patent Literature 1: 3GPP TR36.814 “E-UTRA Further Advancements for E-UTRA Physical Layer Aspects”

### SUMMARY OF INVENTION

### Technical Problem

Now, in relationship to the above-noted radio communication system, the use of a carrier that is not compatible with legacy carriers used in macro cells (hereinafter referred to as an “incompatible carrier,” and also referred to as “NCT” (New Carrier Type) and/or the like) in small cells is under study.

In incompatible carriers, for example, cell-specific reference signals (referred to as “CRSs”) may not be placed (or inserted in a lower density) in order to reduce the interference. Also, in incompatible carriers, it may also be possible not to place a downlink control channel (PDCCH: Physical Downlink Control CHannel) that is placed in maximum three OFDM symbols at the top of a subframe over the whole system bandwidth, in order to improve the throughput.

When coordinated multi-point (CoMP) transmission is executed in a plurality of small cells where such incompatible carriers are used, there is a threat that a user terminal is unable to correct the gap in each small cell in at least one of time and frequency sufficiently (hereinafter referred to as the “time/frequency gap”).

The present invention has been made in view of the above, and it is therefore an object of the present invention to provide a user terminal, a radio base station and a radio communication method, whereby, when CoMP transmission is executed in a plurality of small cells that use incompatible carriers, the time/frequency gap in each small cell can be corrected.

### Solution to Problem

The user terminal of the present invention provides a user terminal that receives a downlink shared channel that is transmitted in coordinated multi-point transmission in a plurality of small cells within a macro cell, and this user terminal has a receiving section that receives configuration information of a detection signal of each small cell, and a synchronization section that establishes synchronization in at least one of time and frequency, based on the configuration information of the detection signal, and acquires first gap information, which represents a gap in at least one of time and frequency, and, in this user terminal, the receiving section receives an association indicator, which represents configuration information of a measurement reference signal that is associated with a demodulation reference signal for the downlink shared channel, and the synchronization section establishes the synchronization based on the configuration information of the measurement reference signal represented by the association indicator, and the first gap information, and acquires second gap information, which represents a gap in at least one of time and frequency.

### Advantageous Effects of Invention

According to the present invention, when CoMP transmission is executed in a plurality of small cells that use incompatible carriers, the time/frequency gap in each small cell can be corrected.

### BRIEF DESCRIPTION OF DRAWINGS

FIG. 1 is a diagram to explain a HetNet;

FIG. 2 is a diagram to explain an example scenario to place small cells densely;

FIG. 3 is a diagram to show an example of interference coordination between small cells;

FIG. 4 is a diagram to show another example of interference coordination between small cells;

FIG. 5 provide diagrams to show examples of a legacy carrier and an incompatible carrier;

FIG. 6 provide diagrams to explain CA scenarios for small cells where incompatible carriers are used, and macro cells;

FIG. 7 is a diagram to explain the time/frequency gap in each small cell that carries out CoMP transmission;

FIG. 8 provide diagrams to explain examples of time/frequency synchronization in user terminals;

FIG. 9 is a flowchart to show the time/frequency synchronization operation in user terminals according to a first example;

FIG. 10 provide diagrams to explain cross-carrier scheduling according to the first example;

FIG. 11 is a diagram to explain time/frequency synchronization according to first and second examples;

FIG. 12 is a flowchart to show the time/frequency synchronization operation in user terminals according to a second example;

FIG. 13 is a diagram to explain EPDCCH sets according to the second example;

FIG. 14 is a diagram to show an overall structure of a radio communication system according to the present embodiment;

FIG. 15 is a diagram to show a schematic structure of a radio base station according to the present embodiment;

FIG. 16 is a diagram to explain a schematic structure of a user terminal according to the present embodiment;

FIG. 17 is a diagram to show a detailed structure of a macro base station according to the present embodiment;

FIG. 18 is a diagram to show a detailed structure of a small base station according to the present embodiment; and

FIG. 19 is a diagram to show a detailed structure of a user terminal according to the present embodiment.

### DESCRIPTION OF EMBODIMENTS

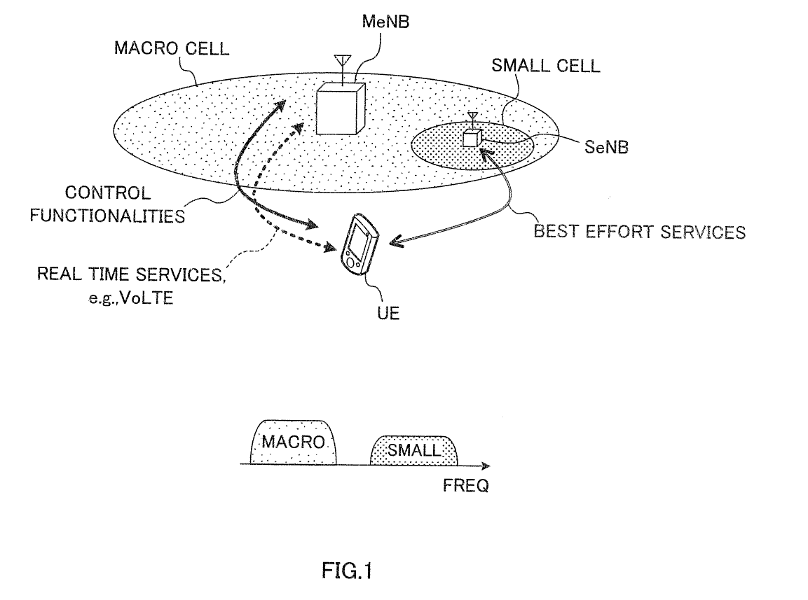

FIG. 1 is a conceptual diagram of a HetNet. The HetNet shown in FIG. 1 is a radio communication system in which a macro cell and a small cell are arranged to physically overlap each other at least in part. That is, the HetNet is comprised of a macro base station that forms a macro cell (referred to as “MeNB” (Macro ENodeB), and also referred to simply as “eNB” (eNodeB)), a small base station that form a small cell (referred to as “SeNB” (Small eNodeB)), and a user terminal (referred to as “UE” (User Equipment)) that communicates with the macro base station and the small base station.

Referring to FIG. 1, a relatively low frequency band (for example, the 800 MHz band, the 2 GHz band and so on) is used in the macro cell, and a relatively high frequency band (for example, 3.5 GHz and so on) is used in the small cell. Also, not only licensed bands such as, for example, 3.5 GHz, but also unlicensed bands, such as, for example, 5 GHz may be used in the small cell. Also, lower transmission power is used in the small cell than in the macro cell.

Also, in relationship to the HetNet, a study is also in progress to improve capacity in small cells and improve the throughput of user terminals, while securing coverage and mobility in macro cells (also referred to as “macro-assisted,” “C/U-plane split,” etc.). To be more specific, there is a plan to carry out control (C)-plane communication to involve control signals and an on in macro cells, and carry out user (U)-plane communication to involve user data and so on in small cells. Note that, as shown in FIG. 1, part of user (U)-plane communication such as real-time-based services may be carried out in macro cells.

Also, with the HetNet, a study is also in progress to provide small cells in varying densities and different environments (for example, indoors, outdoors and so on). Generally speaking, the distribution of users and traffic are not even, but change over time or between locations. For example, it may be possible to raise the density of placing small cells (dense small cells) in train stations, shopping malls and so on where many user terminals gather, and lower the density of placing small cells (sparse small cells) in places where user terminals do not gather.

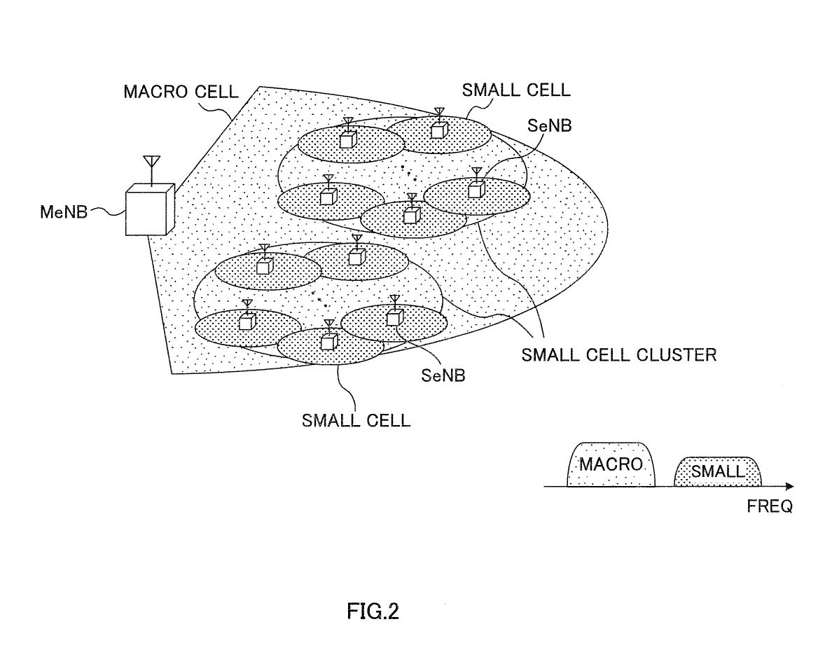

FIG. 2 is a diagram to explain an example scenario to place small cells densely. As shown in FIG. 2, a scenario to place small cells densely in a cluster of a specific range (small cell cluster) may be possible (for example. Rel-12 SCE (Small Cell Enhancement) scenario). In this scenario, the mode of connection (backhaul link) between each cluster and the macro cell and between small cells within a cluster is also subject to study.

On the other hand, if the density of small cells is simply raised, increased interference from nearby small cells might cause a deterioration of received quality (for example, the SINR: Signal to Interference plus Noise Ratio). As a result of this, the effect of improving throughput by increasing the number of small cells might hit the limit. Also, unlike conventional macro cells, small cells are presumed to be placed without cell planning. Furthermore, in order to facilitate cell planning, there is a demand to tolerate interference between small cells and cancel interference signals by interference coordination between small cells.

In this way, in a dense small cell environment, there is a demand to apply interference coordination between small cells. For interference coordination between small cells, it may be possible to apply CoMP transmission and/or on/off control between small cells.

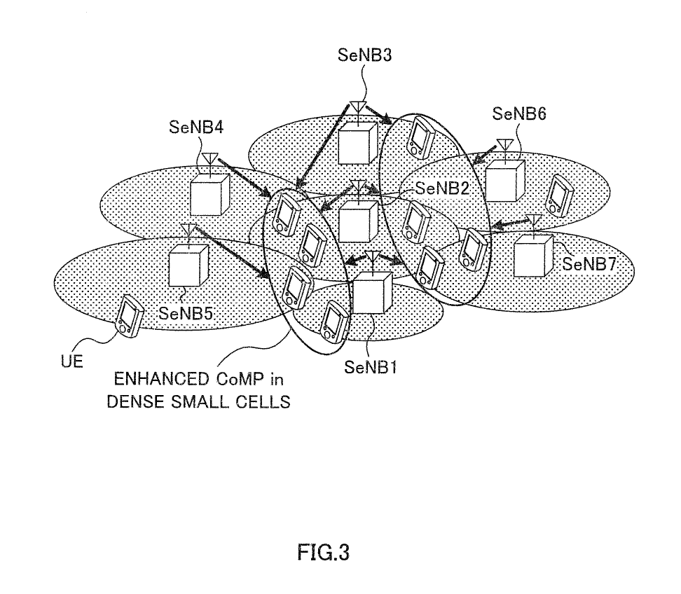

FIG. 3 is a diagram to show an example of interference coordination between small cells. FIG. 3 shows a case where CoMP transmission is employed as interference coordination between small cells. As show in FIG. 3, signals for cell-edge user terminals are transmitted from a plurality of small base stations (for example, small base stations 1 to 5, small base stations 1 to 3, 6 and 7) by way of CoMP transmission.

To be more specific, in CoMP transmission, signals for user terminals may be transmitted simultaneously from a plurality of small base stations (JT: Joint Transmission), or may be transmitted from one small base station that is switched dynamically (DPS: Dynamic Point Selection). Alternatively, signals for a plurality of user terminals may be transmitted from a plurality of small base stations by executing beamforming and/or scheduling in a coordinated manner (CS/CB: Coordinated Scheduling/Beamforming).

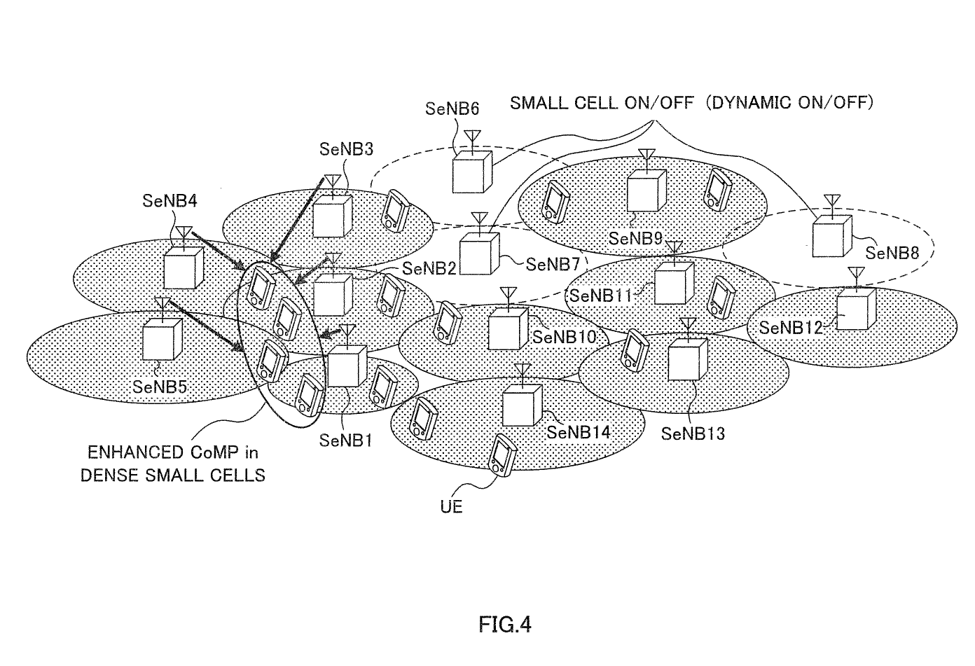

FIG. 4 is a diagram to show another example of interference coordination between small cells. In FIG. 4, on/off control of small cells is employed, together with above-noted CoMP for interference coordination between small cells. As shown in FIG. 4, in on/off control, it is possible to reduce interference from reference signals such as CRSs by deactivating small base stations based on traffic load.

To be more specific, in on/off control, discovery signals that are transmitted from small base stations in a burst enable measurements with respect to small cells that are in the off state, thereby allowing small cells in the off state to transition to the on state, in units of several tens of millimeters. The discovery signals are signals that are provided in a relatively long cycle such as, for example, 100 ms, 160 ms and so on, and are placed densely within a short period such as, for example, 1 ms.

Referring to FIG. 4, CoMP transmission is employed in small base stations 1 to 5, where the traffic load is high (for example, the rate of resources in use is 70% or higher). On the other hand, small base stations 6 to 8, where the traffic load is low (for example, the rate of resources in use is 30% or lower), transition to the off state. In this way, by combining and employing CoMP transmission and on/off control in accordance with the load of traffic, it is possible to improve the effect of reducing interference between small cells.

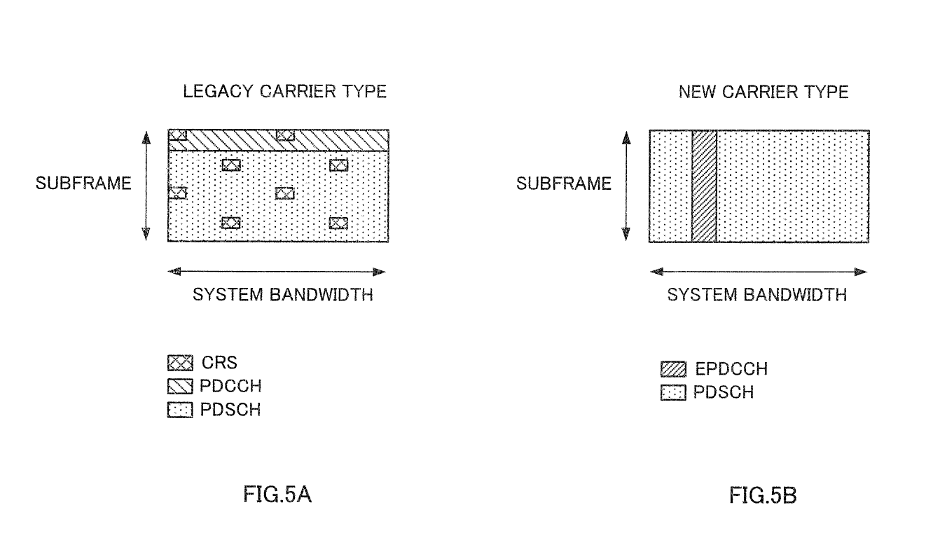

Also, in small cells where interference coordination is executed as described above, the use of an incompatible carrier (NCT: New Carrier Type) that is not compatible with legacy carriers used in macro cells is under study. FIG. 5 provide diagrams to explain an incompatible carrier. FIG. 5A shows an example of a legacy carrier (legacy carrier type), and FIG. 5B shows an example of an incompatible carrier (NCT).

Note that, although FIG. 5 show only cell-specific reference signals (CRSs), a downlink control channel (PDCCH: Physical Downlink Control Channel) and a downlink shared channel (PDSCH: Physical Downlink Shared Channel) for ease of explanation, this is by no means limiting. Demodulation reference signals (DM-RSs), measurement reference signals (CSI-RSs: Channel State Information-Reference Signals) and so on that are not illustrated in FIG. 5 may be placed as well.

As shown in FIG. 5A, in the legacy carrier, the PDCCH is placed in maximum three OFDM symbols at the top of a subframe, over the whole system bandwidth. Also, in the legacy carrier, CRSs are placed. On the other hand, as shown in FIG. 5B, no PDCCH or CRS is placed in the incompatible carrier. Instead, in the incompatible carrier, an enhanced downlink control channel (EPDCCH: Enhanced Physical Downlink Control Channel) that is frequency-division-multiplexed with the PDSCH may be placed.

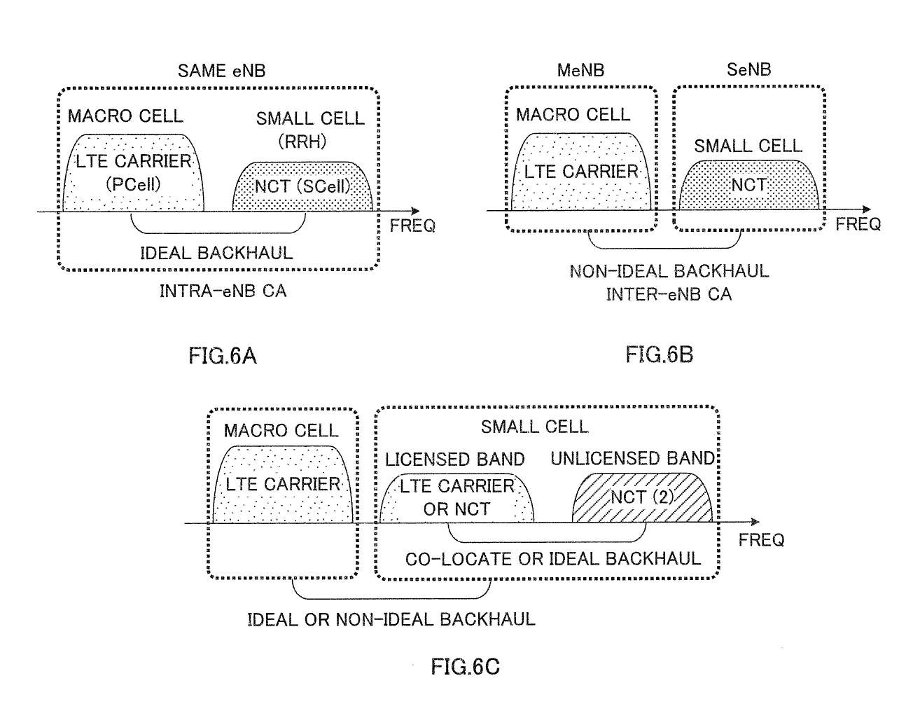

As described above, in future radio communication systems, interference coordination may be executed between small cells using incompatible carriers. Also, it may also be possible to execute carrier aggregation (CA) between small cells using incompatible carriers, and macro cells. FIG. 6 provide diagrams to explain CA scenarios between small cells to use incompatible carriers, and macro cells.

FIG. 6A shows an example of intra-base station (intra-eNB) CA. In FIG. 6A, the macro base station and the small base station (referred to as “RRH” (Remote Radio Head) and so on) are connected via a high-speed channel (ideal backhaul) such as, for example, optical fiber. In this intra-base station CA, CA is executed between the macro cell (PCell), which uses a legacy carrier (LTE carrier), and the small cell (SCell), which uses an incompatible carrier (NCT).

FIG. 6B shows an example of inter-base station (inter-eNB) CA. In FIG. 6B, the macro base station and the small base station are connected via a low-speed channel (non-ideal backhaul) such as the X2 interface. In this inter-base station CA, CA is executed between the macro cell, which uses a legacy carrier (LTE carrier), and the small cell, which uses an incompatible carrier (NCT).

FIG. 6C shows an example of CA between a licensed band and an unlicensed band. In FIG. 6C, the small base station to use the licensed band (for example, 3.5 GHz band and so on) and the small base station to use the unlicensed band (for example, 5 GHz band and so on) are connected via a high-speed channel or a low-speed channel. In the small cell of the licensed band, a legacy carrier (LTE carrier) may be used, or an incompatible carrier (NCT) may be used. On the other hand, in the small cell of the unlicensed band, an incompatible carrier (NCT) may be used. In this CA, CA is executed between the small cell of the licensed band and the small cell of the unlicensed band, and the macro cell.

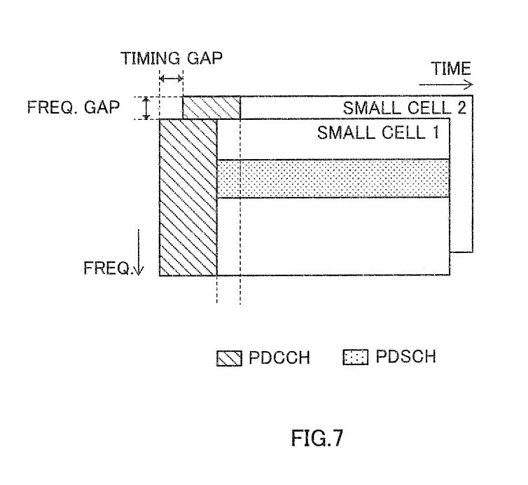

Now, when CoMP transmission is executed for interference coordination between small cells, a user terminal has to correct the gap in each small cell in at least one of time and frequency (hereinafter also referred to as the “time/frequency gap”). FIG. 7 is a diagram to explain the time/frequency gap in each small cell where CoMP transmission is carried out. As shown in FIG. 7, between small cells 1 and 2 that carry out CoMP transmission, at least one of the frequency gap (freq. gap), which is the gap in the frequency direction, and the timing gap, which is the gap in the time direction, is produced. Consequently, there is a threat that a user terminal cannot decode the PDSCH from small cell 1 or from small cell 2 properly.

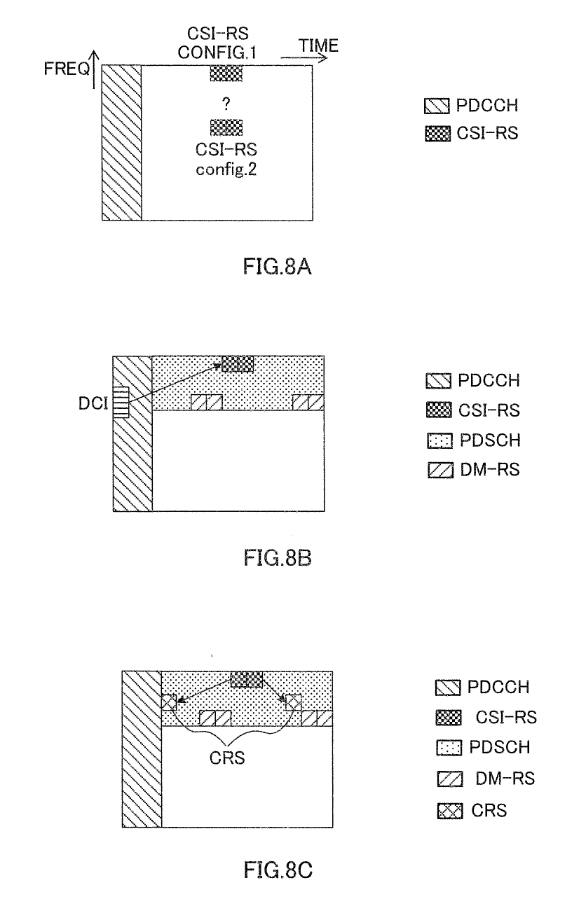

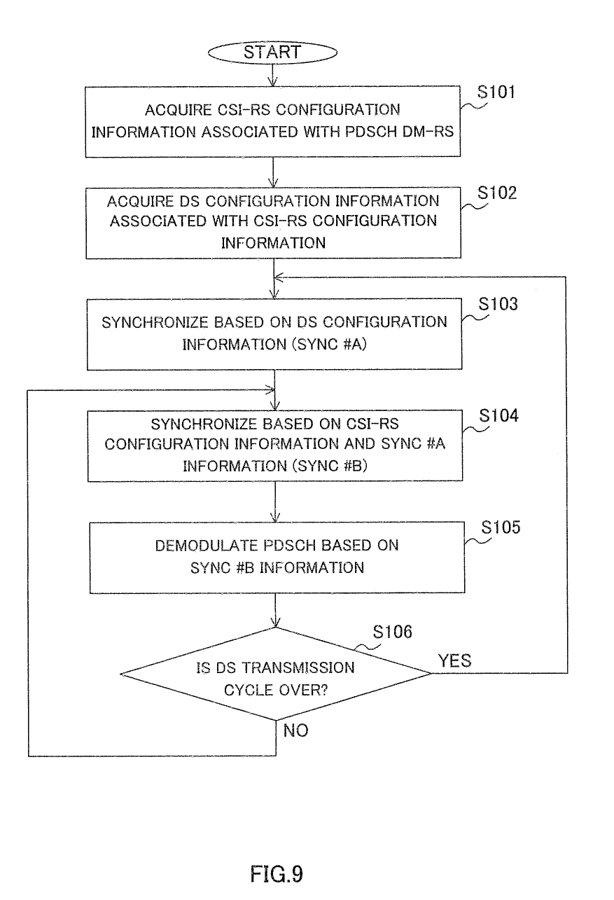

So, it may be possible to correct (i.e. tracking) the time/frequency gap (timing/freq. gap) by allowing the user terminal to establish synchronization in each small cell in at least one of time and frequency (hereinafter referred to as “time/frequency synchronization”). An example of time/frequency synchronization operation in a user terminal in a small cell where a legacy carrier is used will be described with reference to FIGS. 8 and 9.

FIG. 8 provide diagrams to explain the time/frequency synchronization operation in a user terminal. As shown in FIG. 8A, a user terminal has no way of knowing from which small cells PDSCHs are transmitted, and therefore cannot specify CSI-RS configurations. So, as shown in FIG. 8B, the user terminal specifies the CSI-RS configurations (CSI-RS Configs.) used in small cells from which PDSCHs are transmitted, based on PQI values that arc included in downlink control information (DCI).

Here, PQI (Pdsch remapping and Quasi-co-location Indicator) refers to indicators (association indicators) that identify, in a unique manner, a plurality of associations between demodulation reference signals (DM-RSs) for the PDSCH (hereinafter referred to as “PDSCH DM-RSs”) and CSI-RSs. Each PQI value indicates CSI-RS configuration information (for example, a CSI-RS configuration index) that is associated with a PDSCH DM-RS.

For example, when PDSCH DM-RSs and CSI-RSs are provided in four patterns of associations, these four patterns of associations are reported to the user terminal in advance, semi-statically, through higher layer signaling such as RRC (Radio Resource Control) signaling. A PQI value (for example, one of “00,” “01,” “10” and “11”) to represent an association that is selected from these four patterns of associations is reported to the user terminal, dynamically, in DCI (for example, DCI format 2D). Based on this PQI value included in DCI, the user terminal can specify the CSI-RS configuration used in the PDSCH-transmitting small cell.

Next, as shown in FIG. 8C, the user terminal specifies multiplexing information of the CRSs (for example, the cell IDs, the number of CRS ports, the MBSFN (Multicast Broadcast Single Frequency Network) configuration and so on) that are associated with the specified CSI-RS configuration. CSI-RS multiplexing information is reported to the user terminal in advance, semi-statically, through higher layer signaling such as RRC signaling, per CSI-RS configuration.

Based on the specified CSI-RS configuration and the CRS multiplexing information, the user terminal establishes time/frequency synchronization in the small cell transmitting the PDSCH, by using the CSI-RS and the CRS. By this means, when CoMP transmission is executed for interference coordination between small cells where a legacy carrier is used, a user terminal can correct the time/frequency gap in each small cell and decode the PDSCH properly.

Nevertheless, when CoMP transmission is executed for interference coordination between small cells where an incompatible carrier is used, there is a threat that time/frequency synchronization cannot be established in each small cell and each small cell's time/frequency gap cannot be corrected. This is because, unlike legacy carriers, an incompatible carrier has no downlink control channel placed therein, and therefore cannot communicate PQI values. Another reason is that, in an incompatible carrier, CRSs for use in time/frequency synchronization in legacy carriers are not placed (or placed in a low density).

So, assuming cases where CoMP transmission is executed for interference coordination between small cells in which an incompatible carrier is used, the present inventors have studied the method of establishing each small cell's time/frequency synchronization and correcting the time/frequency gap, and arrived at the present invention

To be more specific, the present inventors have focused on the fact that discovery signals are placed in an incompatible carrier, instead of CRSs, and conceived of establishing time/frequency synchronization in each small cell by using the discovery signals. Here, the discovery signals refer to detection signals that are used to detect small cells, and are placed in a cycle such as, for example, 100 ms and 160 ms, which is longer than that of CSI-RSs. The discovery signals may be signals that are based on CSI-RSs, PRSs (Positioning Reference Signals), Reduce CRSs, or may be signals that are stipulated anew.

Furthermore, the present inventors have come up with the idea of reporting PQI values (association indicators of PDSCH DM-RSs and CSI-RSs) to user terminals through cross-carrier scheduling from a macro cell or by using an enhanced downlink control channel (EPDCCH: Enhanced Physical Downlink Control Channel) that is frequency-division-multiplexed with the PDSCH, and establishing time/frequency synchronization in small cells by using CSI-RSs. The CSI-RSs are channel state information (CSI) measurement reference signals.

In this way, a user terminal according to the present invention establishes time/frequency synchronization by using discovery signals, and furthermore, based on the result of this time/frequency synchronization, establishes time/frequency synchronization by using CSI-RSs. In this way, even when CoMP transmission is executed in a plurality of small cells where an incompatible carrier is used, each small cell's time/frequency gap can be corrected.

Now, the present embodiment will be described below in detail with reference to the accompanying drawings.

### FIRST EXAMPLE

A case will be described with a first example where a macro cell assists CoMP transmission in a plurality of small cells in which an incompatible carrier is used (for example, a CA scenario for a macro cell and a small cell (see FIG. 6)). In this case, a user terminal carries out C-plane communication in the macro cell.

To be more specific, in the first example, a user terminal receives a PQI value that is subject to cross-carrier scheduling via the PDCCH of the macro cell. Also, based on the configuration information of the discovery signal (hereinafter referred to as “DS configuration information”) that is associated with the configuration information of the CSI-RS (hereinafter referred to as “CSI-RS configuration information”) represented by the PQI value, the user terminal executes time/frequency synchronization using the discovery signal (sync #A, which will be described later).

Also, the user terminal establishes time/frequency synchronization (sync #B, which will be described later) based on the CSI-RS configuration information that is represented by the PQI value, and based on first gap information (sync #A information, which will be described later) that is acquired from the above time/frequency synchronization (sync #A, which will be described later). The user terminal demodulates the PDSCH based on second gap information (sync #B information, which will be described later) that is acquired from this time/frequency synchronization (sync #B, which will be described later). Here, the first gap information and the second gap information each represent gap in at least one of time and frequency.

The time/frequency synchronization operation in a user terminal according to the first example will be described below with reference to FIGS. 9 to 11. FIG. 9 is a flowchart to show the time/frequency synchronization operation in a user terminal according to the first example. Assume that, in FIG. 9, the macro base station reports a plurality of pieces of CSI-RS configuration information that may be used in small cells, to the user terminal, as a plurality of associations of PDSCH DM-RSs and CSI-RSs, through higher layer signaling (for example, RRC signaling). The CSI-RS configuration information is, for example, the indices of CSI-RS configurations.

Also, assume that, in FIG. 9, the macro base station reports CSI-RS configuration-specific DS configuration information, to the user terminal, as associations of CSI-RS configuration-specific CSI-RSs and discovery signals, through higher layer signaling (for example, RRC signaling). The DS configuration information may include, for example, the transmission cycle, the transmission period and the start offset of the discovery signals.

As shown in FIG. 9, the user terminal acquires the CSI-RS configuration information associated with each small cell's PDSCH DM-RS (step S101). To be more specific, the user terminal acquires DCI, which is subject to cross-carrier scheduling in the macro base station (PCell) and which is transmitted from the macro base station via the PDCCH. This DCI includes a CIF (Carrier Indicator Field) value, which shows which small base station (SCell) the scheduling information pertains to, and a PQI value.

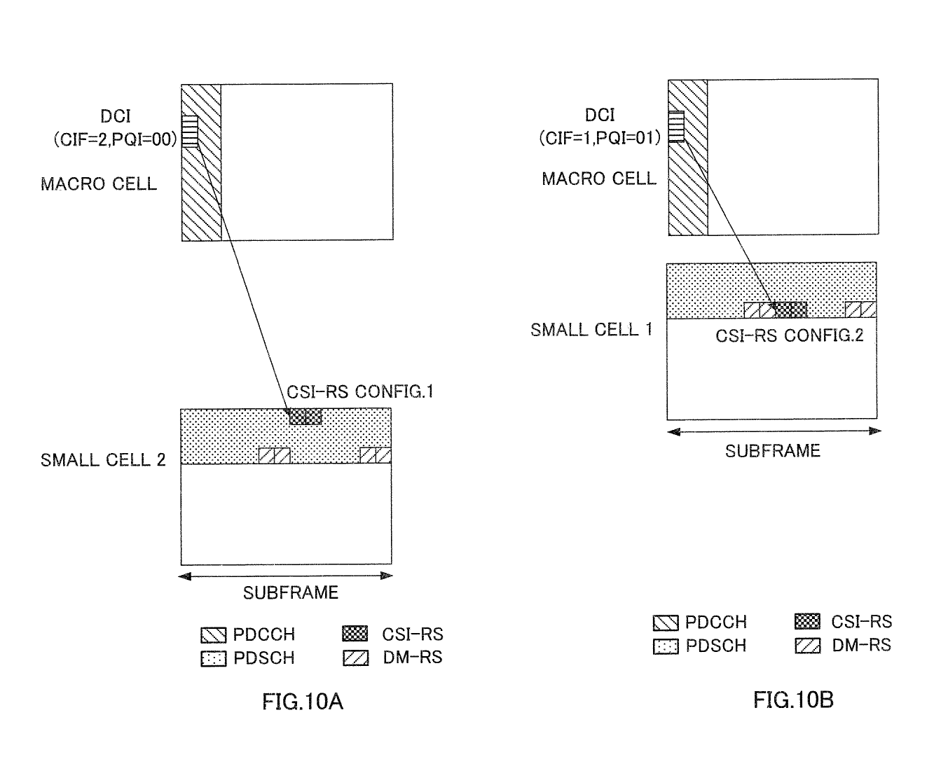

FIG. 10 provide diagrams to explain PQI values that are subject to cross-carrier scheduling. For example, in FIG. 10A, the CIF value designates small cell 2 and the PQI value designates CSI-RS configuration 1, so that the user terminal detects the use of CSI-RS configuration 1 in small cell 2. Also, in FIG. 10B, the CIF value designates small cell 1 and the PQI value designates CSI-RS configuration 2, so that the user terminal detects the use of CSI-RS configuration 2 in small cell 1.

The user terminal acquires the DS configuration information that is associated with each small cell's CSI-RS configuration information that is detected (step S102). As mentioned earlier, CSI-RS configuration-specific DS configuration information is reported to the user terminal through higher layer signaling.

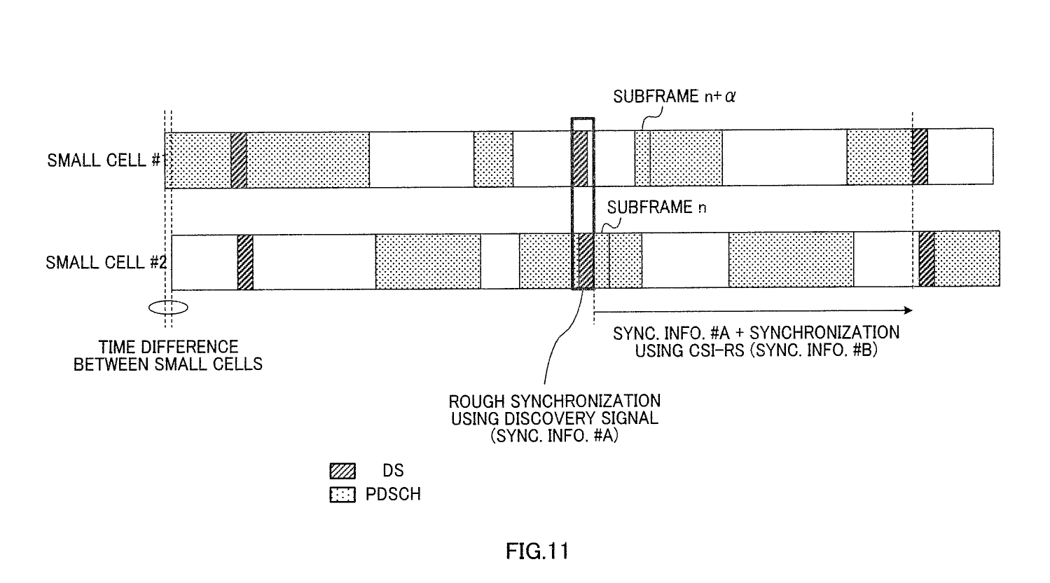

The user terminal establishes time/frequency synchronization (sync #A) with respect to each small cell, by using the discovery signals, based on each small cell's DS configuration information that is acquired (step S103). FIG. 11 is a diagram to explain the time/frequency synchronization to use discovery signals (sync #A), and time/frequency synchronization to use CSI-RSs (sync #B), which will be described later.

If, for example, the PQI values shown in FIG. 10 are subject to cross-carrier scheduling in FIG. 11, the user terminal establishes time/frequency synchronization by using the discovery signal (hereinafter also referred to as “DS”) of small cell 1, based on the DS configuration information that is associated with CSL-RS configuration 2. Similarly, the user terminal establishes time/frequency synchronization by using the discovery signal of small cell 2, based on the DS configuration information that corresponds to CSI-RS configuration 1. In this way, by establishing time/frequency synchronization (sync #A) all together using the discovery signals of small cells 1 and 2, the user terminal corrects each small cell's time/frequency gap roughly. The user terminal holds each small cell's first time/frequency gap information (hereinafter referred to as “sync #A information,” or “sync. info. #A” in FIG. 11) acquired in this way until the next discovery signal arrives.

Next, the user terminal executes the time/frequency synchronization to use CSI-RSs (sync #B) with respect to each small cell, based on the CSI-RS configuration information that is associated with each small cell's PDSCH DM-RS (step S104). To be more specific, the user terminal establishes time/frequency synchronization based on the CSI-RS configuration information represented by the PQI values received in step S101, and based on each small cell's sync #A information, acquired from the DSs associated with the CSI-RSs represented by the PQI values.

For example, in subframe n in FIG. 11, the user terminal establishes the time/frequency synchronization of small cell 2 based on CSI-RS configuration 1 and sync #A information of small cell 2, which is acquired from the DS associated with CSI-RS configuration 1 represented by the PQI value. Also, in subframe n+α, the user terminal establishes the time/frequency synchronization of small cell 1 based on CSI-RS configuration 2 and the sync #A information of small cell 1, which is acquired from the DS associated with CSI-RS configuration 2 represented by the PQI value. From this time/frequency synchronization (sync #B), second time/frequency gap information (hereinafter referred to as “sync #B information,” or “sync. info. #B” in FIG. 11), which is more accurate than sync #A information, can be acquired.

The user terminal demodulates the PDSCHs (step S105). For example, in subframe n in FIG. 11, the user terminal demodulates the PDSCH transmitted from small cell 2, based on the sync #B information acquired from the time/frequency synchronization (sync #B). Furthermore, in subframe n+α in FIG. 11 the user terminal demodulates the PDSCH transmitted from small cell 1, based on the sync #B information acquired from the time/frequency synchronization (sync #B).

The user terminal determines whether or not the discovery signal transmission is over (step S106). If the discovery signal transmission cycle is over (step S106: Yes), the operation returns to step S103, and the time/frequency synchronization to use discovery signals (sync #A) is executed. If the discovery signal transmission cycle is not over (step S106: No), the operation returns to step S104, and the time/frequency synchronization to use CSI-RSs (sync #B) is repeated.

As described above, according to the first example, PQI values are subject to cross-carrier scheduling. Also, the user terminal of the first example executes time/frequency synchronization (sync #A) by using discovery signals based on DS configuration information that is associated with the CSI-RS configurations represented by the PQI values. Furthermore, based on the CSI-RS configuration information represented by the PQI values and sync #A information that is acquired by the time/frequency synchronization (sync #A), the user terminal executes time/frequency synchronization (sync #B). Also, the user terminal demodulates PDSCHs based on sync #B information that is acquired from the time/frequency synchronization (sync #B). By this means, even when CoMP transmission is executed in a plurality of small cells in which an incompatible carrier is used, the user terminal still can correct each small cell's time/frequency gap.

### SECOND EXAMPLE

A case will be described now with a second example where a macro cell does not assist CoMP transmission in a plurality of small cells in which an incompatible carrier is used. That is, according to the second example, a plurality of small cells that carry out CoMP transmission do not have to execute CA with the macro cell.

To be more specific, according to the second example, a user terminal detects the CSI-RS configurations for EPDCCH sets, which are assigned to each small cell, and establishes time/frequency synchronization (sync #A) based on the DS configuration information that is associated with the CSI-RS configurations. Note that the user terminal may establish time/frequency synchronization (sync #A) based on the above CSI-RS configurations, in addition to the DS configuration information. The user terminal demodulates each small cell's EPDCCH based on sync #A information that is acquired from the above time/frequency synchronization (sync #A).

Also, the user terminal receives PQI values via each small cell's EPDCCH, and, based on the CSI-RS configuration information represented by the PQI values and the sync #A information acquired from the time/frequency synchronization (sync #A), executes time/frequency synchronization (sync #B). The user terminal demodulates PDSCHs based on sync #B information acquired from this time/frequency synchronization (sync #B).

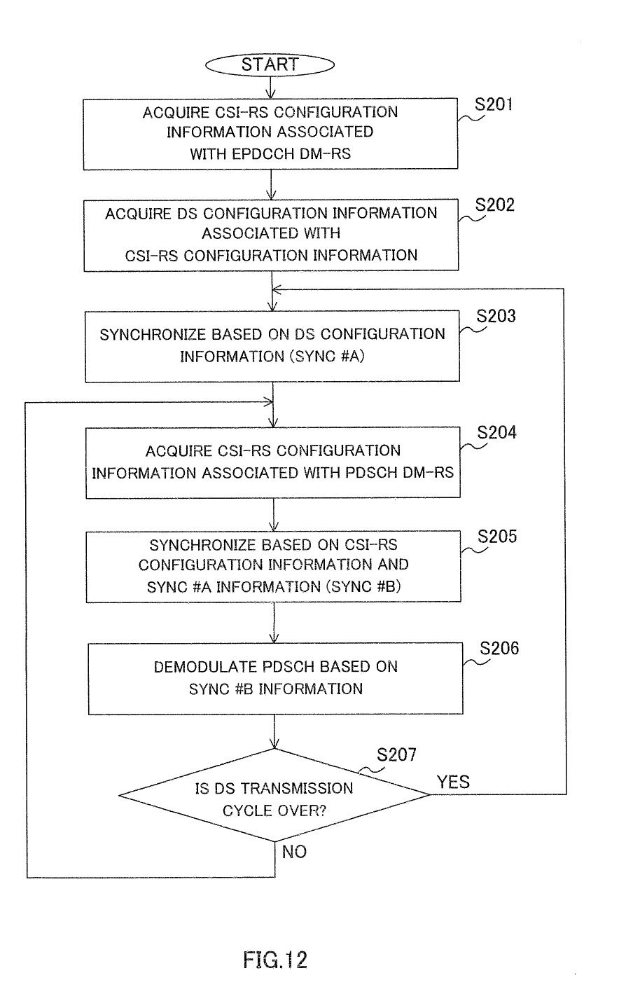

The time/frequeney synchronization operation in a user terminal according to the second example will be described with reference to FIGS. 11 to 13. Note that the time/frequency synchronization (sync #A and #B) shown in FIG. 11 is employed in the second example as well. FIG. 12 is a flowchart to show the time/frequency synchronization operation in a user terminal according to the second example. Assume that, in FIG. 12, the small base stations report a plurality of pieces of CSI-RS configurations that may be used in the small cells, to the use terminal, as a plurality of associations of PDSCH DM-RSs and CSI-RSs, through higher layer signaling (for example, RRC signaling).

Also, assume that, in FIG. 12, the small base stations report CSI-RS configuration-specific DS configuration information to the user terminal, as associations of CSI-RS configuration-specific CSI-RSs and discovery signals, through higher layer signaling (for example, RRC signaling). The DS configuration information may include, for example, the transmission cycle, the transmission period and the start offset of the discovery signals.

Also, assume that, in FIG. 12, the small base stations report EPDCCH set-specific CSI-RS configurations to the user terminal, as associations of EPDCCH DM-RSs and CSI-RSs per EPDCCH set, through higher layer signaling (for example, RRC signaling). Here, an EPDCCH set is comprised of at least one PRB (Physical Resource Block) pair that is allocated to the EPDCCH. The EPDCCH sets contain mutually different PRB pairs.

As shown in FIG. 12, the user terminal acquires the CSI-RS configuration information (for example, CSI-RS configuration indices) that is associated with the EPDCCH DM-RS of each small cell (the EPDCCH set assigned thereto) (step S201). As mentioned earlier, the CSI-RS configuration information of each EPDCCH set is reported to the user terminal through higher layer signaling.

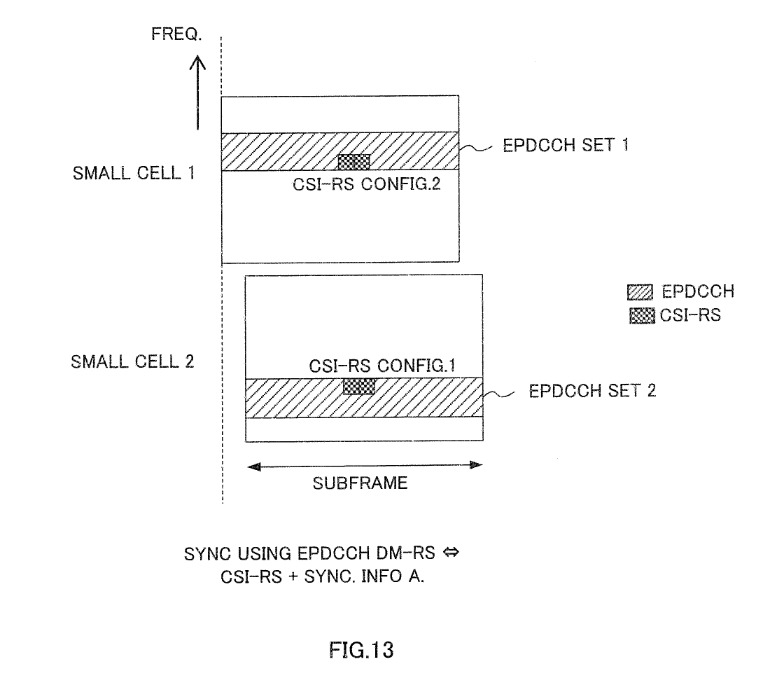

FIG. 13 is a diagram to explain the associations of EPDCCH DM-RSs and CSI-RSs. In FIG. 13, CSI-RS configuration 2 is associated with EPDCCH set 1 that is assigned to small cell 1. Also, CSI-RS configuration 1 is associated with EPDCCH set 2 that is assigned to small cell 2.

The user terminal acquires the DS configuration information that is associated with the CSI-RS configuration of each EPDCCH set (step S202). As mentioned earlier, CSI-RS configuration-specific DS configuration information is reported to the user terminal through RRC signaling. The DS configuration information may include, for example, the discovery signals' transmission cycle, transmission period and start offset to the subframe top.

The user terminal executes the time/frequency synchronization to use discovery signals (sync #A), for each small cell, based on the DS configuration information of each EPDCCH set acquired (step S203). In this case, the user terminal may establish time/frequency synchronization in the small cells where each EPDCCH set is assigned, based on the CSI-RS configuration information of each EPDCCH set, in addition to the DS configuration information of each EPDCCH set.

For example, if, in FIG. 11, CSI-RS configurations 2 and 1 are associated with EPDCCH sets 1 and 2, respectively, as shown in FIG. 13, the user terminal establishes time/frequency synchronization in small cell 1 based on CSI-RS configuration 2 and the DS configuration information that is associated with CSI-RS configuration 2. Likewise, the user terminal establishes time/frequency synchronization in small cell 2 based on CSI-RS configuration 1 and the DS configuration information that is associated with CSI-RS configuration 1. By means of sync #A information that is acquired from this time/frequency synchronization (sync #A), the user terminal can properly demodulate EPDCCH sets 1 and 2.

The user terminal acquires the CSI-RS configuration information (for example, CSI-RS configuration indices) associated with each small cell's PDSCH DM-RS (step S204). To be more specific, the user terminal receives DCI (for example, DCI format 2D) that includes PQI values from the small base stations via the EPDCCH, and acquires the CSI-RS configuration information represented by the PQI values.

For example, in subframe n in FIG. 11, the user terminal acquires a PQI value by blind-decoding EPDCCH set 2, and detects the use of CSI-RS configuration 1 in small cell 2. Also, in subframe n+α, the user terminal acquires a PQI value by blind-decoding EPDCCH set 1, and detects the use of CSI-RS configuration 2 in small cell 1.

The operation of steps S205 to S207 are the same as the operation of step S104 to S106 in FIG. 10 and therefore will not be described again.

As described above, the user terminal according to the second example acquires the CSI-RS configuration information that is associated with each EPDCCH set, and establishes time/frequency synchronization (sync #A) based on the CSI-RS configuration information and the DS configuration information that is associated with the CSI-RS configuration information. Also, the user terminal establishes time/frequency synchronization (sync #B) based on the CSI-RS configuration information represented by the PQI values communicated in the EPDCCH, and sync #A information acquired from the time/frequency synchronization (sync #A). Also, the user terminal demodulates PDSCHs based on sync #B information acquired from this time/frequency synchronization (sync #B). By this means, even when CoMP transmission is executed in a plurality of small cells in which an incompatible carrier is used, the user terminal still can correct each small cell's time/frequency gap.

(Radio Communication System)

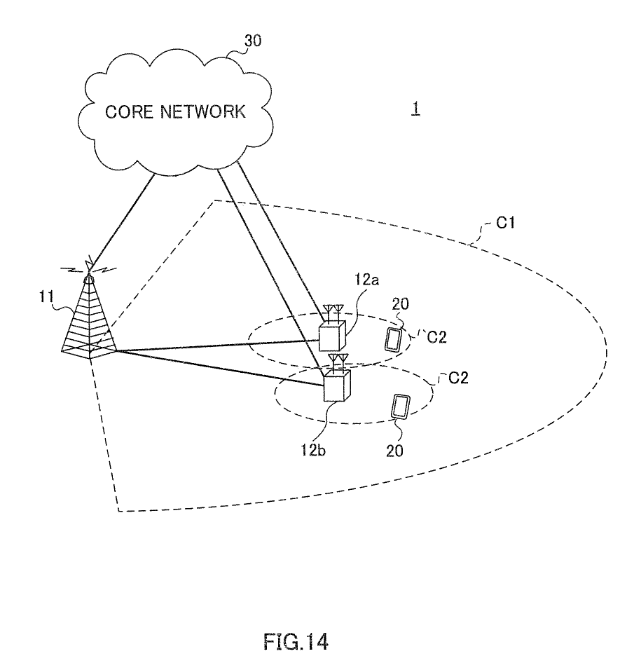

Now, the structure of the radio communication system according to the present embodiment will be described. FIG. 14 is a diagram to show an overall structure of a radio communication system 1 according to the present embodiment. Note that the radio communication system 1 shown in FIG. 14 is, for example, an LTE system or a system to incorporate SUPER 3G. This radio communication system employs carrier aggregation, whereby a plurality of fundamental frequency blocks (component carriers) are grouped into one, where the LTE system bandwidth constitutes one unit. Also, this radio communication system may be referred to as “IMT-advanced,” or may be referred to as “4G,” “FRA (Future Radio Access),” etc.

As shown in FIG. 14, the radio communication system 1 includes a macro base station 11, which forms a macro cell C1, and small base stations 12a and 12b, which are placed in the macro cell C1 and which form small cells C2 that are narrower than the macro cell C1. Also, user terminals 20 are placed in the macro cell C1 and in each small cell C2. Note that the number of macro cells C1 (macro base stations 11), small cells C2 (small base stations 12) and user terminals 20 is not limited to that shown in FIG. 11.

Also, user terminals 20 are placed in the macro cell C1 and in each small cell C2. The user terminals 20 are configured to be capable of carrying out radio communication with the macro base station 11 and/or the small base station 12.

Between the user terminals 20 and the macro base station 11, communication is carried out using a carrier of a relatively low frequency band (for example, 2 GHz). Meanwhile, between the user terminals 20 and the small base stations 12, communication can be carries out using a carrier of a relatively high frequency band (for example, 3.5 GHz). Also, the user terminal 20 may communicate with the small base stations 12 by using a carrier of a licensed band of, for example, 3.5 GHz, or may communicate with the small base stations 12 by using an unlicensed band of, for example, 5 GHz.

The carrier (first carrier) which the macro base station 11 (macro cell C1) uses is referred to as a legacy carrier (also referred to as “legacy carrier type,” “LTE carrier,” etc.) and so on (see FIG. 5A). The carrier (second carrier) which the small base stations 12 (small cells C2) use is not compatible with legacy carriers, and is referred to as an “incompatible carrier” (also referred to as “NCT” (New Carrier Type)) and so on (see FIG. 5B). Note that the small base stations 12 (small cells C2) can use legacy carriers as well (see FIG. 6C).

The macro base station 11 and the small base stations 12 may be connected via a relatively high-speed channel (ideal backhaul) such as optical fiber, or may be connected via a relatively low-speed channel (non-ideal backhaul) such as the X2 interface. In the event connection is established with a relatively high-speed channel, the macro base station 11 and the small base stations 12 carry out intra-base station carrier aggregation (intra-eNB CA) (see FIG. 6A). In the event connection is established using a relatively low-speed channel, the macro base station 11 and the small base stations 12 carry out inter-base station carrier aggregation (inter-eNB CA) (see FIG. 6B).

Similarly, the small base stations 12a and 12b may be connected with a relatively high-speed channel (ideal backhaul) such as optical fiber, or may be connected via a relatively low-speed channel (non-ideal backhaul) such as the X2 interface.

The macro base station 11 and the small base stations 12 are each connected with a core network 30. In the core network 30, core network devices such as an MME (Mobility Management Entity), an S-GW (Serving-GateWay), a P-GW (Packet-GateWay) and so on are provided.

Also, the macro base station 11 is a radio base station having a relatively wide coverage, and may be referred to as an “eNodeB,” a “macro base station,” an “aggregation node,” a “transmission point,” a “transmitting/receiving point” and so on. The small base stations 12 are radio base stations that have local coverages, and may be referred to as “small base stations,” “pico base stations,” “femto base stations,” “HeNBs (Home eNodeBs),” “RRHs (Remote Radio Heads),” “micro base stations,” “transmission points,” “transmitting/receiving points” and so on.

Also, if no distinction is made between the macro base station 11 and the small base stations 12, these will be collectively referred to as the “radio base station 10.” The user terminals 20 are terminals to support various communication schemes such as LTE, LTE-A, FRA and so on, and may include both mobile communication terminals and stationary communication terminals.

Also, in the radio communication system 1, a downlink shared channel (PDSCH: Physical Downlink Shared CHannel), which is used by each user terminal 20 on a shared basis, a downlink control channel (PDCCH: Physical Downlink Control CHannel), an enhanced downlink control channel (EPDCCH: Enhanced Physical Downlink Control CHannel), a broadcast channel (PBCH) and so on are used as downlink physical channels. User data and higher layer control information are communicated by the PUSCH. Downlink control information (DCI) is communicated by the PDCCH and the EPDCCH.

Also, in the radio communication system 1, an uplink shared channel (PUSCH: Physical Uplink Shared CHannel), which is used by each user terminal 20 on a shared basis, and an uplink control channel (PUCCH: Physical Uplink Control CHannel) are used as uplink physical channels. User data and higher layer control information are communicated by the PUSCH. Also, downlink channel state information (CSI: Channel State Information, CQI: Channel Quality Indicator, and so on), delivery acknowledgment information (ACK/NACK) and so on are communicated by the PUCCH.

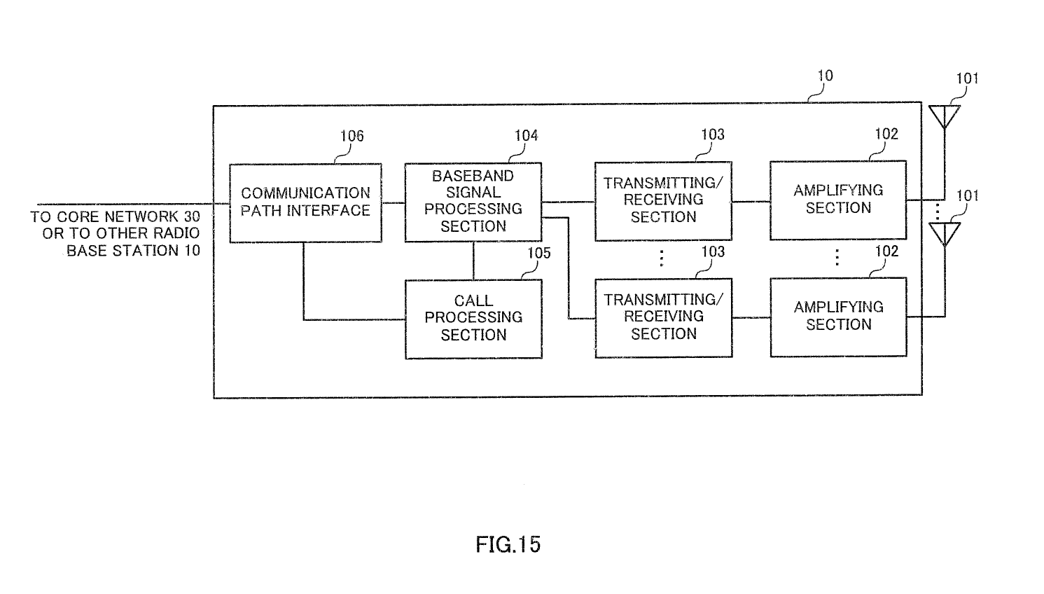

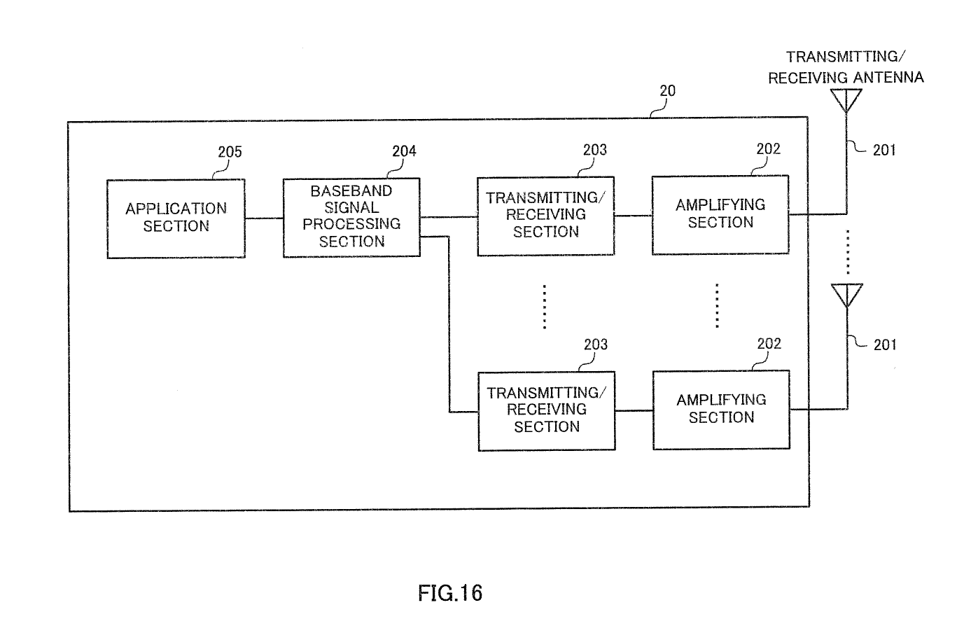

Now, overall structures of a radio base station 10 (which may be either a macro base station 11 or a small base station 12) and a user terminal 20 will be described with reference to FIGS. 15 and 16. FIG. 15 is a diagram to show an overall structure of the radio base station 10. As shown in FIG. 15, the radio base station 10 has a plurality of transmitting/receiving antennas 101 for MIMO communication, amplifying sections 102, transmitting/receiving sections 103 (transmitting section and receiving section), a baseband signal processing section 104, a call processing section 105 and a transmission path interface 106.

User data to be transmitted from the radio base station 10 to the user terminal 20 on the downlink is input from the S-GW provided in the core network 30, into the baseband signal processing section 104, via the transmission path interface 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control signals (including reference signals, synchronization signals, broadcast signals, etc.) are also subjected to transmission processes such as channel coding and an inverse fast Fourier transform, and are forwarded to each transmitting/receiving section 103.

Each transmitting/receiving section 103 converts the downlink signals, pre-coded and output from the baseband signal processing section 104 on a per antenna basis, into a radio frequency. The amplifying sections 102 amplify the radio frequency signals having been subjected to frequency conversion, and transmit the signals through the transmitting/receiving antennas 101.

On the other hand, as for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, the user data that is included in the input uplink signals is subjected to an FFT process, an IDFT process, error correction decoding, a MAC retransmission control receiving process and RLC layer and PDCP layer receiving processes, and the result is forwarded to the core network 30 via the transmission path interface 106. The call processing section 105 performs call processing such as setting up and releasing communication channels, manages the state of the radio base station 10 and manages the radio resources.

FIG. 16 is a diagram to show an overall structure of a user terminal 20 according to the present embodiment. The user terminal 20 has a plurality of transmitting/receiving antennas 201 for MIMO communication, amplifying sections 202, transmitting/receiving sections (transmitting section and receiving section) 203, a baseband signal processing section 204 and an application section 205. Note that the user terminal 20 may switch the receiving frequency using one receiving circuit (RF circuit), or may have a plurality of receiving circuits.

As for downlink signals, radio frequency signals that are received in a plurality of transmitting/receiving antennas 201 are each amplified in the amplifying sections 202, subjected to frequency conversion in the transmitting/receiving sections 203, and input in the baseband signal processing section 204. In the baseband signal processing section 204, an FFT process, error correction decoding, a retransmission control receiving process and so on are performed. The user data that is included in the downlink signals is forwarded to the application section 205. The application section 205 performs processes related to higher layers above the physical layer and the MAC layer. Furthermore, in the downlink data, broadcast information is also forwarded to the application section 205.

Meanwhile, uplink user data is input from the application section 205 to the baseband signal processing section 204. In the baseband signal processing section 204, a retransmission control (H-ARQ (Hybrid ARQ)) transmission process, channel coding, precoding, a DFT process, an IFFT process and so on are performed, and the result is forwarded to each transmitting/receiving section 203. The baseband signal that is output from the baseband signal processing section 204 is converted into a radio frequency in the transmitting/receiving sections 203. After that, the amplifying sections 202 amplify the radio frequency signals having been subjected to frequency conversion, and transmit the resulting signals from the transmitting/receiving antennas 201.

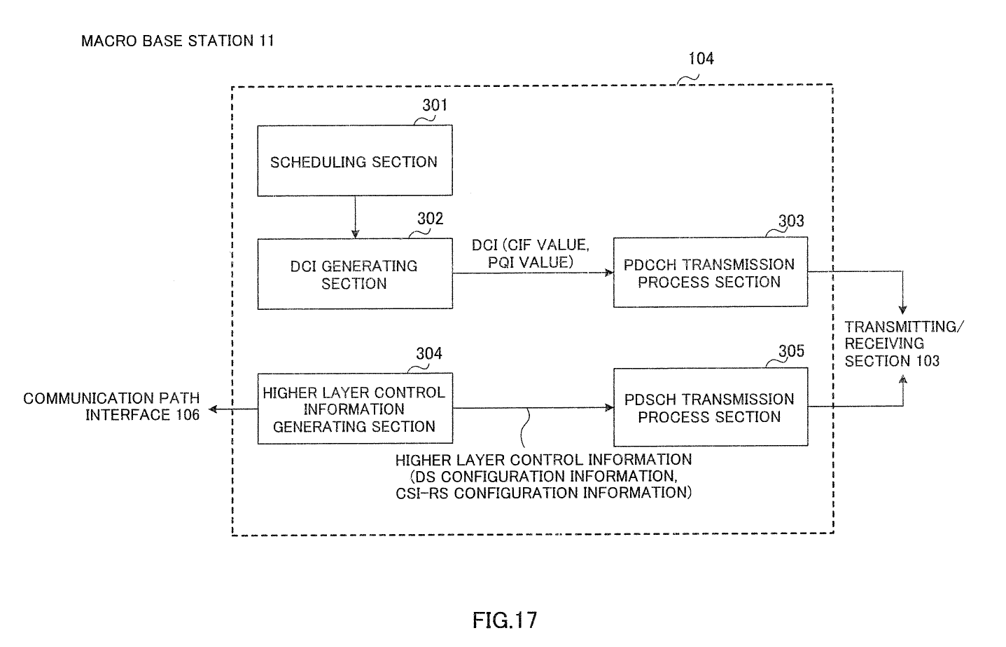

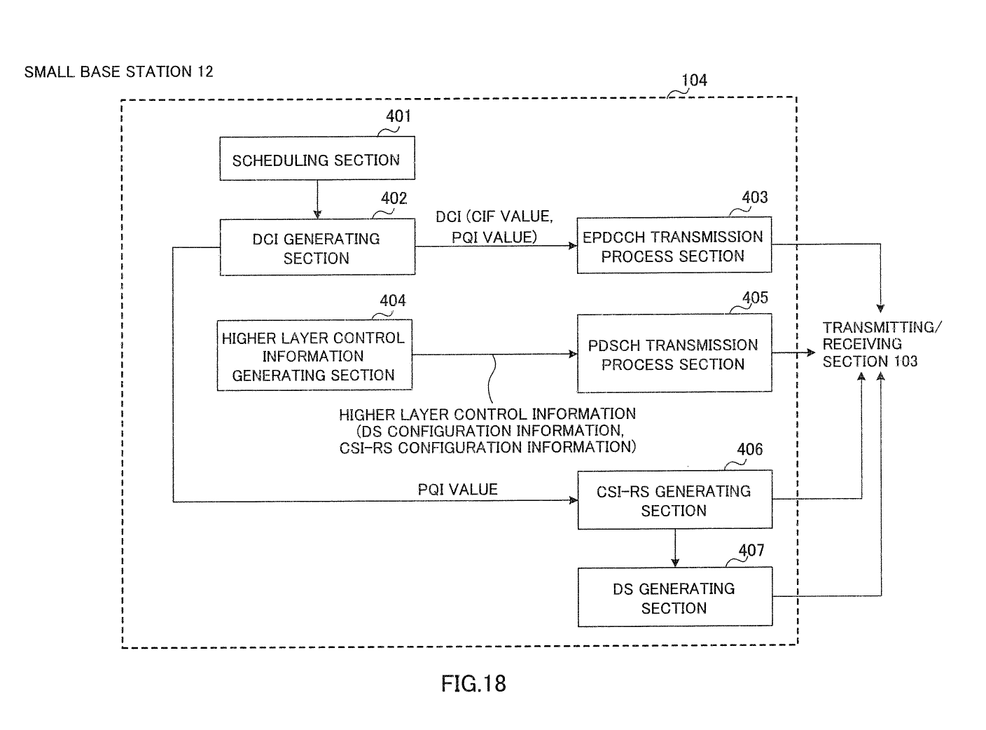

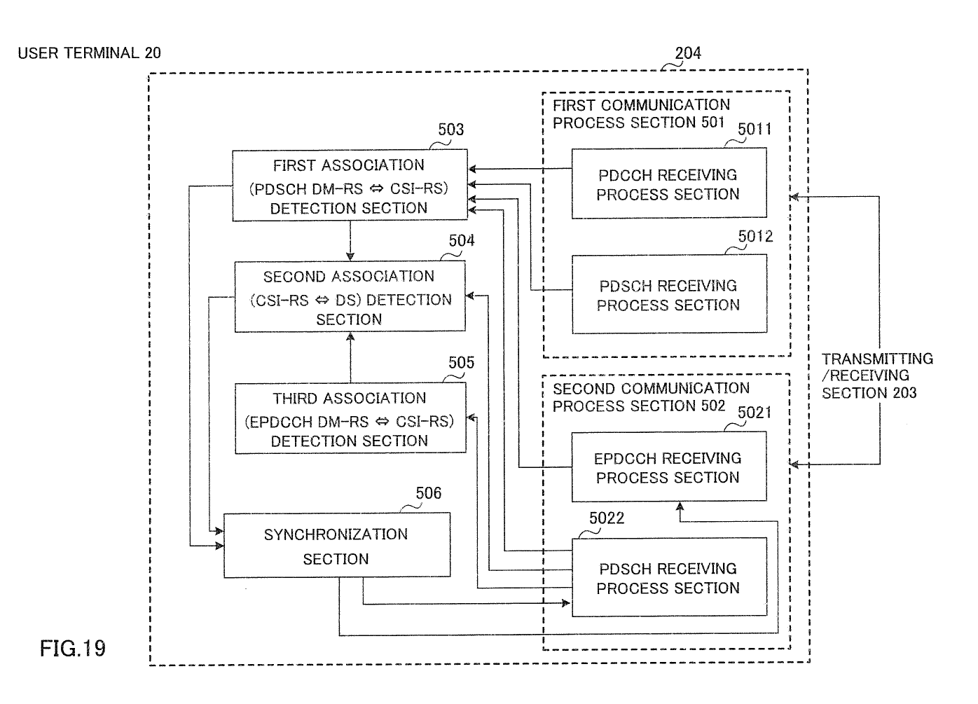

Next, detailed structures of the macro base station 11, the small base stations 12 and the user terminals 20 will be described with reference to FIG. 17 to FIG. 19. The detailed structures of a macro base station 11 shown in FIG. 17 and a small base station 12 shown in FIG. 18 are each comprised primarily of o baseband signal processing section 104. Also, the detailed structure of a user terminal 20 shown in FIG. 19 is comprised primarily of a baseband signal processing section 204.

FIG. 17 is a diagram to show a detailed structure of a macro base station 11 according to the present embodiment. As shown in FIG. 17, the macro base station 11 is comprised of a scheduling section 301, a DCI generating section 302, a PDCCH transmission process section 303, a higher layer control information generating section 304 and a PDSCH transmission process section 305.

The scheduling section 301 allocates resources to user terminals 20 that serve under small base stations 12 (cross carrier scheduling). To be more specific, the scheduling section 301 allocates PDSCHs that are transmitted from small base stations 12 to user terminals 20. The scheduling section 301 outputs scheduling information to show the result of allocation, to the DCI generating section 302.

The DCI generating section 302 generates DCI. To be more specific, the DCI generating section 302 generates DCI (for example, DCI format 2D), which includes scheduling information that is input from the scheduling section 301, a CIF value and a PQI value. As mentioned earlier, the CIF value indicates which small base station 12 (SCell) the scheduling information pertains to. Also, the PQI value indicates the CSI-RS configuration information (for example, the CSI-RS configuration index) that is associated with the PDSCH DM-RS. The DCI is output to the PDCCH transmission process section 303.

The PDCCH transmission process section 303 performs processes (for example, coding, modulation, IFFT and so on) for transmitting the DCI generated in the DCI generating section 302 via the PDCCH.

The higher layer control information generating section 304 generates, for example, higher layer control information to be reported to the user terminals 20 through higher layer signaling such as RRC signaling. The higher layer control information at least includes a plurality of pieces of CSI-RS configuration information that are associated with PDSCH DM-RSs, and DS configuration information that is associated with CSI-RSs on a per CSI-RS configuration basis. Also, the higher layer control information may include CSI-RS configuration information that is associated with EPDCCH DM-RSs on a per EPDCCH set basis. The higher layer control information is output to the PDSCH transmission process section 305.

The PDSCH transmission process section 305 performs processes (for example, coding, modulation, IFFT and so on) for transmitting the higher layer control information generated in the higher layer control information generating section 304 via the PDSCH.

Note that, in the first example of the present invention, the higher layer control information may be output from the higher layer control information generating section 304 to the small base stations 12 via the communication path interface 106 (first example). Also, in the second example of the present invention, the structure of the macro base station 11 shown in FIG. 17 may be omitted.

FIG. 18 is a diagram to show a detailed structure of a small base station 12 according to the present embodiment. As shown in FIG. 18, the small base station 12 has a scheduling section 401, a DCI generating section 402, an EPDCCH transmission process section 403, a higher layer control information generating section 404, a PDSCH transmission process section 405, a CSI-RS generating section 406 and a DS generating section 407.

The scheduling section 401 allocates resources to user terminals 20 that serve under the subject station. To be more specific, the scheduling section 401 allocates the PDSCH transmitted from the transmitting/receiving sections 103 to the user terminals 20. The scheduling section 401 outputs scheduling information, which shows the result of allocation, to the DCI generating section 402.

The DCI generating section 402 generates DCI. To be more specific, the DCI generating section 402 generates DCI (for example, DCI format 2D) that includes the scheduling information that is input from the scheduling section 401, a CIF value and a PQI value. As mentioned earlier, the PQI value indicates the CSI-RS configuration information (for example, the CSI-RS configuration index) that is associated with the PDSCH DM-RS. The DCI is output to the EPDCCH transmission process section 403.

The EPDCCH transmission process section 403 performs processes (for example, coding, modulation, IFFT and so on) for transmitting the DCI generated in the DCI generating section 402, via the EPDCCH.

The higher layer control information generating section 404 generates, for example, higher layer control information to be reported to user terminals 20 through higher layer signaling such as RRC signaling. The higher layer control information includes a plurality of pieces of CSI-RS configuration information that are associated with PDSCH DM-RSs, CSI-RS configuration information that is associated with EPDCCH DM-RSs on a per EPDCCH set basis, and DS configuration information that is associated with CSI-RSs on a per CSI-RS configuration basis. The higher layer control information is output to the PDSCH transmission process section 405.

The PDSCH transmission process section 405 performs processes (for example, coding, modulation, IFFT and so on) for transmitting the higher layer control information generated in the higher layer control information generating section 404 via the PDSCH.

The CSI-RS generating sec on 406 generates CSI-RSs (measurement reference signals) and outputs these to the transmitting/receiving sections 103. To be more specific, the CSI-RS generating section 406 generates CSI-RSs based on the CSI-RS configuration information (for example, CSI-RS configuration index) represented by the PQI value.

The DS generating section 407 generates discovery signals (detection signals) and outputs these to the transmitting/receiving sections 103. To be more specific, the DS generating section 407 generates discovery signals based on the DS configuration information associated with the CSI-RS configuration information. As described above, the DS configuration information includes the discovery signals' transmission cycle, transmission period, start offset and so on.

Note that in the first example of the present invention, the scheduling section 401, the DCI generating section 402, the EPDCCH transmission process section 403, the higher layer control information generating section 404 and the PDSCH transmission process section 405 may be omitted.

FIG. 19 is a diagram to show a detailed structure of a user terminal 20 according to the present embodiment. As shown in FIG. 19, the user terminal 20 has a first communication process section 501, a second communication process section 502, a first association detection section 503, a second association detection section 504, a third association detection section 505 and a synchronization section 506.

The first communication process section 501 performs communication processes to use a legacy carrier (first carrier) with respect to the macro base station 11. To be more specific, the first communication process section 501 has a PDCCH receiving process section 5011 and a PDSCH receiving process section 5012. Note that, since PQI values are reported using the EPDCCH in the second example of the present invention, the first communication process section 501 may be omitted.

The PDCCH receiving process section 5011 performs processes (for example, FFT, demodulation, blind-decoding and so on) for receiving DCI via the PDCCH.

The PDSCH receiving process section 5012 performs processes (for example, FFT, demodulation, decoding and so on) for receiving higher layer control information via the PDSCH. As mentioned earlier, the higher layer control information includes a plurality of pieces of CSI-RS configuration information that are associated with PDSCH DM-RSs, and DS configuration information that is associated with CSI-RSs on a per CSI-RS configuration basis. Note that the higher layer control information may also include CSI-RS configuration information that is associated with EPDCCH DM-RSs on a per EPDCCH set basis.

The second communication process section 502 performs communication processes to use an incompatible carrier (second carrier) with respect to the small base stations 12. To be more specific, the second communication process section 502 has an EPDCCH receiving process section 5021 and a PDSCH receiving process section 5022.

The EPDCCH receiving process section 5021 performs processes (for example, FFT, demodulation, blind-decoding and so on) for receiving DCI via the EPDCCH. To be more specific, the EPDCCH receiving process section 5021 executes blind-decoding for every EPDCCH set, and acquires the DCI for each terminal. As mentioned earlier, every small base station 12 that carries out CoMP transmission is assigned an EPDCCH set.

The PDSCH receiving process section 5022 performs processes (for example, EFT, demodulation, decoding and so on) for receiving higher layer control information and user data via the PDSCH. As mentioned earlier, the higher layer control information includes a plurality of pieces of CSI-RS configuration information that are associated with PDSCH DM-RSs, DS configuration information that is associated with CSI-RSs on a per CSI-RS configuration basis, and CSI-RS configuration information that is associated with EPDCCH DM-RSs on a per EPDCCH set basis.

The first association detection section 503 detects the CSI-RS configuration information associated with PDSCH DM-RSs. To be more specific, the first association detection section 503 detects the CSI-RS configuration information that is represented by the PQI value (association indicator), from a plurality of pieces of CSI-RS configuration information associated with PDSCH DM-RSs.

The second association detection section 504 detects the DS configuration information associated with the CSI-RS configuration information. To be more specific, the second association detection section 504 may detect the DS configuration information that is associated with the CSI-RS configuration information detected in the first association detection section 503 (first example). Alternatively, the second association detection section 504 may detect the DS configuration information that is associated with the CSI-RS configuration information detected in the third association detection section 505, which will be described later (second example).

The third association detection section 505 detects CSI-RS configuration information that is associated with EPDCCH DM-RSs. To be more specific, the third association detection section 505 detects the CSI-RS configuration information that is associated with the EPDCCH DM-RS of each EPDCCH set. As mentioned earlier, every small base station 12 that carries out CoMP transmission may be assigned an EPDCCH set (see FIG. 13).

The synchronization section 506 establishes synchronization in at least one of time and frequency (time/frequency synchronization), in order to properly decode the PDSCH from each small base station 12 that carries out CoMP transmission. To be more specific, the synchronization section 506 executes time/frequency synchronization (sync #A) based on the DS configuration information that is detected in the second association detection section 504, and acquires first time/frequency gap information (sync #A information). Also, the synchronization section 506 executes time/frequency synchronization (sync #B) based on the CSI-RS configuration information that is detected in the first association detection section 503 and the sync #A information, and acquires second time/frequency gap information (sync #B information).

Also, the synchronization section 506 outputs the sync #B information to the PDSCH receiving process section 5022. The PDSCH receiving process section 5022 demodulates the PDSCH based on the sync #B information.

Also, in the first example of the present invention, the synchronization section 506 may execute time/frequency synchronization (sync #A) based on the CSI-RS configuration information that is detected in the third association detection section 505, in addition to the DS configuration information that is detected in the second association detection section 504, and output the sync #A information to the EPDCCH receiving process section 5021. The EPDCCH receiving process section 5021 demodulates the EPDCCH based on the sync #A information.

The synchronization section 506 may execute the time/frequency synchronization (sync #A) based on DS configuration information in along cycle (for example, 100 ms, 160 ms and so on) and execute the time/frequency synchronization (sync #B) based on CSI-RS configuration information and sync #A information in a short cycle (for example, 5 ms and so on).

As described above, according to the radio communication system 1 of the present embodiment, the user terminal 20 establishes time/frequency synchronization (sync #A) based on DS configuration information, and, furthermore, establishes time/frequency synchronization (sync #B) based on CSI-RS configuration information and sync #A information. Consequently, even when CoMP transmission is executed in a plurality of small base stations 12 where an incompatible carrier is used, it is still possible to correct the time/frequency gap of each small base station 12.

Now, although the p sent invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of claims. Also, the examples described above can be combined and employed as appropriate. Consequently, the description herein is only provided for the purpose of illustrating examples, and should by no means be construed to limit the present invention in any way.

The disclosure of Japanese Patent Application No. 2013-270088, filed on Dec. 26, 2013, including the specification, drawings and abstract, is incorporated herein by reference in its entirety.

1. A user terminal that receives a downlink shared channel that is transmitted in coordinated multi-point transmission in a plurality of small cells within a macro cell, the user terminal comprising:
a receiving section that receives configuration information of a detection signal of each small cell; and
a synchronization section that establishes synchronization in at least one of time and frequency, based on the configuration information of the detection signal, and acquires first gap information, which represents a gap in at least one of time and frequency, wherein:
the receiving section receives an association indicator, which represents configuration information of a measurement reference signal that is associated with a demodulation reference signal for the downlink shared channel; and
the synchronization section establishes the synchronization based on the configuration information of the measurement reference signal represented by the association indicator, and the first gap information, and acquires second gap information, which represents a gap in at least one of time and frequency.

2. The user terminal according to claim 1, further comprising a demodulation section that demodulates the downlink shared channel based on the second gap information.

3. The user terminal according to claim 1, wherein:
the receiving section receives configuration information of a plurality of measurement reference signals associated with downlink shared channel demodulation reference signals, through higher layer signaling; and
the association indicator represents configuration information of one measurement reference signal that is selected from the configuration information of the plurality of measurement reference signals.

4. The user terminal according to claim 3, wherein the receiving section receives the association indicator, which is subject to cross-carrier scheduling, via a downlink control channel of the macro cell.

5. The user terminal according to claim 4, wherein the configuration information of the detection signal is associated with the configuration information of the measurement reference signal represented by the association indicator.

6. The user terminal according to claim 3, wherein the receiving section receives the association indicator via an enhanced downlink control channel that is frequency-division-multiplexed with the downlink shared channel.

7. The user terminal according to claim 6, wherein:
configuration information of a measurement reference signal of each small cell is associated with a demodulation reference signal for an enhanced downlink control channel set that is assigned to each small cell;
the configuration information of the detection signal is associated with the configuration information of the measurement reference signal of each small cell;
the synchronization section establishes the synchronization based on the configuration information of the detection signal and the configuration information of the measurement reference signal, and acquires the first gap information; and
the demodulation section demodulates the enhanced downlink control channel based on the first gap information.

8. The user terminal according to claim 1, wherein each small cell uses a second carrier, which is not compatible with a first carrier used in the macro cell.

9. A radio base station that forms a small cell in which a downlink shared channel for a user terminal is transmitted in coordinated multi-point transmission within a macro cell, the radio base station comprising:
a generating section that generates a detection signal of the small cell, a measurement reference signal of the small cell and a downlink shared channel that is demodulated using a demodulation reference signal associated with configuration information of the measurement reference signal; and
a transmission section that transmits the detection signal, the measurement reference signal and the downlink shared channel,
wherein the detection signal and the measurement reference signal are used to establish synchronization in at least one of time and frequency in the user terminal.

10. A radio communication method for use in a radio communication system in which a user terminal receives a downlink shared channel that is transmitted in coordinated multi-point transmission in a plurality of small cells within a macro cell, the radio communication method comprising, in the user terminal, the steps of:
receiving configuration information of a detection signal of each small cell; and
establishing synchronization in at least one of time and frequency, based on the configuration information of the detection signal, and acquiring first gap information, which represents a gap in at least one of time and frequency;
receiving an association indicator, which represents configuration information of a measurement reference signal that is associated with a demodulation reference signal for the downlink shared channel; and
establishing the synchronization based on the configuration information of the measurement reference signal represented by the association indicator, and the first gap information, and acquiring second gap information, which represents a gap in at least one of time and frequency.

11. The user terminal according to claim 2, wherein:
the receiving section receives configuration information of a plurality of measurement reference signals associated with downlink shared channel demodulation reference signals, through higher layer signaling; and
the association indicator represents configuration information of one measurement reference signal that is selected from the configuration information of the plurality of measurement reference signals.

12. The user terminal according to claim 11, wherein the receiving section receives the association indicator, which is subject to cross-carrier scheduling, via a downlink control channel of the macro cell.

13. The user terminal according to claim 12, wherein the configuration information of the detection signal is associated with the configuration information of the measurement reference signal represented by the association indicator.

14. The user terminal according to claim 11, wherein the receiving section receives the association indicator via an enhanced downlink control channel that is frequency-division-multiplexed with the downlink shared channel.

15. The user terminal according to claim 14, wherein:
configuration information of a measurement reference signal of each small cell is associated with a demodulation reference signal for an enhanced downlink control channel set that is assigned to each small cell;
the configuration information of the detection signal is associated with the configuration information of the measurement reference signal of each small cell;
the synchronization section establishes the synchronization based on the configuration information of the detection signal and the configuration information of the measurement reference signal, and acquires the first gap information; and
the demodulation section demodulates the enhanced downlink control channel based on the first gap information.

16. The user terminal according to claim 2, wherein each small cell uses a second carrier, which is not compatible with a first carrier used in the macro cell.
